(19) United States
(12) Patent Application Publication
(10) Pub. No.: US 2009/0208600 A1
(43) Pub. Date: Aug. 20, 2009

(54) Injection Molding Machine

(75) Inventor: Masaharu Akamatsu, Hong Kong (CN)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: SUMITOMO HEAVY INDUSTRIES, LTD

(21) Appl. No.: 12/225,067

(22) PCT Filed: Mar. 9, 2007
(86) PCT No.: PCT/JP2007/054708

§ 371 Date: Sep. 12, 2008

(30) Foreign Application Priority Data
Mar. 13, 2006 (JP) 2006-068106

(51) Int. Cl. B29C 45/78

(52) U.S. Cl. 425/144

(57) ABSTRACT

An injection molding machine is equipped with a heating cylinder (11) to which a molding material is supplied and a screw (13) that is driven in the cylinder to meter the molding material. A plurality of heaters (41-1 to 41-4) are provided in alignment in an axial direction of the cylinder so as to individually heat each part of the heating cylinder (11) at a predetermined setting temperature. A cylinder temperature controller (40) individually controls the setting temperatures by the heaters (41-1 to 41-4). When a predetermined one of the setting temperatures by the heater (41-1 to 41-4) is set, the cylinder temperature controller (40) acquires the rest of the setting temperatures by calculation based on molding conditions.

### TECHNICAL FIELD

The present invention relates to injection molding machines and, more particularly, to an injection molding machine equipped with an injection apparatus that heating melting and injecting a resin as a molding material by heating by a heater provided to a heating cylinder.

### BACKGROUND ART

In an injection apparatus of a general injection molding machine, a screw type injection apparatus is used in many cases. With the screw type injection apparatus, a resin is supplied from an end side of a heating cylinder, and the resin is melted by shear by a rotation of a screw while the resin is heated within the heating cylinder. The melted resin is metered within the heating cylinder and injected from a nozzle at a tip of the heating cylinder.

The nozzle side at the tip of the heating cylinder is needed to be maintained at a melting temperature of the resin. On the other hand, it is necessary to cool the resin supply side so that the resin is not softened and melted. Accordingly, a cooler is provided to the resin supply side so as to cool the end of the heating cylinder opposite to the nozzle. Thus, the nozzle side of the heating cylinder is maintained at a high temperature equal to or higher than the melting temperature, and the resin supply side is maintained at a low temperature at which the resin is not softened and melted.

Generally, in the heating cylinder, an area between a cooler and a nozzle is divided into a plurality of zones in a longitudinal direction thereof, and a heater is provided independently to each zone. By controlling heating by the heater of each zone, a resin is properly heated while moving in the heating cylinder. That is, a temperature control is performed so that the nozzle side is at a high temperature and it is gradually decreased to be a low temperature at the supply side (for example, refer to Patent Document 1).

The temperature at the end of the heating cylinder, which is the nozzle side, is determined by a kind of a resin material, and, generally, set to a temperature designated by a resin material manufacturer, for example, at a high temperature of about 270° C. On the other hand, at the cooler of the resin supply side, it is set to a low temperature of about 70° C. Accordingly, the temperature slope is set along the longitudinal direction of the heating cylinder so that it rises from a temperature close to 70° C. to a high temperature of about 270° C.

Thus, although the temperature of the zone on the nozzle side is set at the designated temperature (for example, 270° C.) and the temperature at the cooler is set to the cooling temperature (for example, 70° C.), the operator of the molding machine is required to arbitrarily set the temperature at the intermediate zones thereof. Therefore, the above-mentioned temperature slope is dependent on the setting temperature of each zone set arbitrarily set by the operator based on experience.

Patent reference 1: Japanese Laid-Open Patent Application No. 9-262886

### DISCLOSURE OF INVENTION

### Problem to be Solved by the Invention

For example, a consideration is given to a case of molding a very small molded product by an injection molding machine. When molding a molded product of a certain size, a resin supplied to a heating cylinder moves within the heating cylinder by taking a certain period of time (hereinafter, referred to as a staying time). The resin is heated by the heating cylinder while moving, and is melted by receiving a sharing force by a screw. That is, the resin supplied to the heating cylinder is in the heating cylinder during the staying time, and is heated by the heating cylinder. The above-mentioned staying time depends on a volume of the molded product (that is, a stroke of the screw at the time of injection) and a mold cycle time.

If a volume of a molded product is large, an amount of resin injected in one cycle is increased, which increases a moving speed of the resin in the heating cylinder. Accordingly, the staying time of the resin in the heating cylinder becomes short. If an amount of heat supplied is small, the metering time may vary or a bite may occur in an outer periphery of the screw. In this case, in order to sufficiently heat the resin by the heating cylinder, it is necessary to heat the supplied resin immediately at a high temperature by setting a temperature setting value of a zone in the vicinity of the position after the cooler. The temperature distribution in the heating cylinder is set to a temperature profile in which it rises sharply from a position after the exit of the cooler and approaches the temperature setting value of the zone at the tip of the heating cylinder and maintained at the temperature setting value of the zone at the tip of the heating cylinder. In this case, it becomes a flat temperature profile, which indicates almost even temperature from the tip of the heating cylinder to the rear end close to the cooling cylinder.

Additionally, if the one mold cycle is short, an amount of resin injected for a unit time is increased, which increases the moving speed of the resin in the heating cylinder. Accordingly, the staying time of the resin in the heating cylinder becomes short, and, similar to the case where the volume of the molded product is large, it is necessary to heat the supplied resin immediately at a high temperature by setting the temperature setting value of a zone in the vicinity of the position after the cooler. That is, the temperature distribution in the heating cylinder is set to a temperature profile in which it rises sharply from a position after the exit of the cooler and approaches the temperature setting value of the zone at the tip of the heating cylinder and maintained at the temperature setting value of the zone at the tip of the heating cylinder. Also in this case, it becomes a flat temperature profile.

Here, consideration will be given of a case in which the volume of the molded product becomes small or a case where a mold cycle time is increased. In this case, contrary to the above-mentioned case, the amount of injection of the resin is decreased, and the staying time of the resin in the heating cylinder becomes long. Thereby, the time during which the resin is heated by the heating cylinder is increased. Accordingly, there is no need to heat the supplied resin immediately at a high temperature, and it is preferable to set to a temperature profile in which it rises gradually from a position at the exit of the cooler and approaches the temperature setting value of the tip of the heating cylinder and injected immediately after it becomes the temperature setting value of the zone at the tip of the heating cylinder. This is because a problem may occur in that alteration of the resin due to heat is promoted when the melted resin is maintained at a high temperature for a long time.

For example, if the melted resin at a high temperature stays in the heating cylinder for a long time, there may be a problem occurs in which a so-called resin burn occurs and the resin is decomposed. Additionally, in a case where the molded product is an optical component, for example, the resin may be altered due to heating for a long time, which may cause a problem in that a transparency of the molded product is failed and a function as an optical component is failed. Further, in a case where the volume of the molded product is very small or the mold cycle is long, if the temperature profile is in a state close to a flat, a problem may occur in that a metered amount varies. Accordingly, it is necessary for a very small molded product or a molded product requiring a long time mold cycle to set the temperature profile of the heating cylinder to a setting in which there is an inclination in an axial direction of the screw moving rearward (different from a normal case).

However, an inexperienced operator does not recognize the above-mentioned problems in many cases, and sets a temperature without considering the temperature profile, and, as a result, the above-mentioned problem occurs.

The present invention is made in view of the above-mentioned problem, and the object is to provide an injection molding machine that can appropriately adjust a temperature profile of a heating cylinder based on a molded product or a mold cycle time.

### Means to Solve the Problems

In order to achieve the above-mentioned objects, there is provided according to the present invention an injection molding machine equipped with a cylinder to which a molding material is supplied and a metering member that is driven in the cylinder to meter the molding material, comprising: a plurality of heaters provided in alignment in an axial direction of the cylinder so as to individually heat each part of said cylinder at a predetermined setting temperature; and a controller that individually controls the setting temperatures of the plurality of heaters, wherein, when the setting temperature corresponding to a position where a melted resin is accumulated in front of a screw at a time of completion of metering is set from among said setting temperatures by said plurality of heaters, said controller acquires said setting temperatures other than the heater by calculation based on molding conditions.

In the injection molding machine according to the present invention, it is preferable that the cylinder includes a nozzle part on a side that injects the resin, a cooling cylinder part on a side where the resin is supplied, and a cylinder body part extending between the nozzle part and the cooling cylinder part, and wherein the predetermined one of the setting temperatures is a setting temperature of the heater at a position of the cylinder body part near said nozzle part, and the setting temperatures other than the predetermined one are the setting temperatures from the heater at a position secondly close to the nozzle part to the heater closest to the cooling cylinder.

Additionally, in the above-mentioned invention, it is preferable that the molding conditions include information regarding at least one of a mold cycle time, a metering stroke of the metering member, and a kind of the resin. Further, the injection molding machine according to the present invention may comprise a cooling part that cools an end side of the cylinder, and the controller may automatically set a setting temperature of the cooling part. Additionally, the controller may correct the setting temperature acquired by the calculation based on the predetermined one of the setting temperatures.

### EFFECT OF THE INVENTION

According to the above-mentioned invention, a temperature profile of the heating cylinder, which heats the molding material such as a resin, can be appropriately adjusted based on a size of the molded product and a mold cycle time. Thereby, a magnitude of heating of the molding material in the cylinder can be adjusted, alteration of the molding material due to heating can be prevented, and a bite can be prevented. Further, a temperature of the resin melted in front of the screw can be set constant.

### BRIEF DESCRIPTION OF DRAWINGS

FIG. 1 is an entire structure diagram of an electric injection molding machine provided with an injection apparatus according to a first embodiment of the present invention.

FIG. 2 is a cross-sectional view of a heating cylinder illustrated in FIG. 1.

FIG. 3 is an illustration indicating a temperature profile of the heating cylinder.

### EXPLANATION OF REFERENCE SIGNS

10 injection apparatus
11 heating cylinder
11A nozzle part
11B heating cylinder body part
11C cooling cylinder part
12 hopper
13 screw
13a flight
20 mold-clamping apparatus
40 cylinder temperature controller
41-1, 41-2, 41-3, 41-4, 41-5 heater

### BEST MODE FOR CARRYING OUT THE INVENTION

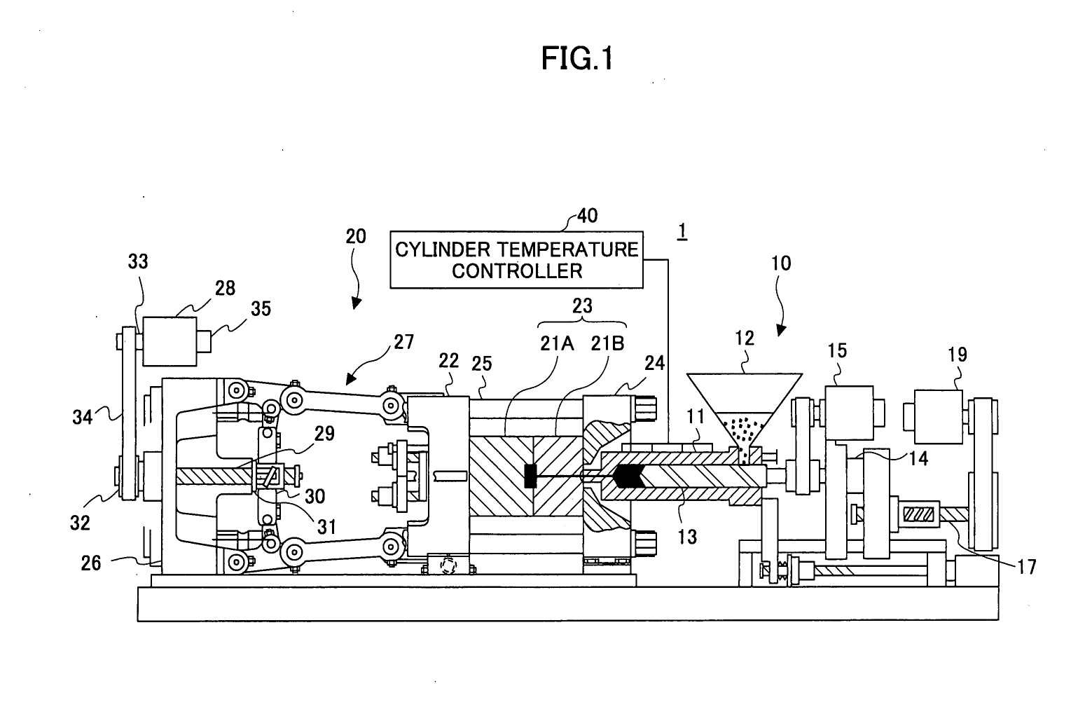

Next, a description will be given, with reference to FIG. 1, of an electric injection molding machine as an example of an injection molding machine to which the present invention is applied. FIG. 1 is an entire structure diagram of an electric injection molding machine provided with an injection apparatus according to a first embodiment of the present invention.

First, a description will be given of the entire electric injection molding machine. The electric injection molding machine 1 illustrated in FIG. 1 comprises an injection apparatus 10 and a mold-clamping apparatus 20.

The injection apparatus 10 is equipped with a heating cylinder 11, and the heating cylinder 11 is provided with a hopper 12. A screw 13 is provided movably forward and rearward and rotatably in the heating cylinder 11. A rear end of the screw 13 is rotatably supported by a support member 14. A metering motor 15 such as a servomotor or the like is attached as a drive part to the support member 14. A rotation of the metering motor 15 is transmitted to the screw 13, which is a driven part, via a timing belt attached to an output shaft.

The injection apparatus 10 has a screw shaft 17 parallel to the screw 13. A rear end of the screw shaft 17 is connected to an output shaft of an injection motor 19 via a timing belt. Accordingly, the screw shaft 17 can be rotated by the injection motor 19. A front end of the screw shaft 17 is in engagement with a nut fixed to the support member 14. By driving the injection motor 19 to rotate the screw shaft 17 through the timing belt, the support member 14 is movable forward and rearward, which results in the screw 13, which is a driven part, being movable forward and rearward.

The mold-clamping apparatus 20 has a movable platen 22 to which a movable mold 21A is attached and a stationary platen 24 to which a stationary mold 21B is attached. A mold apparatus is formed by the movable platen 21A and the stationary platen 21B. The movable platen 22 and the stationary platen 24 are connected by tie bars 25. The movable platen 22 is slidable along the tie bars 25. Additionally, the mold-clamping apparatus 20 has a toggle mechanism 27 of which one end is coupled with the movable platen 22 and the other end is coupled with a toggle support 26. At the central part of the toggle support 26, a ball screw shaft 29 is supported rotatably. A nut 31 formed in a crosshead 30 provided to the toggle mechanism 27 is in engagement with the ball screw shaft 29. Additionally, a pulley 32 is provided to a rear end of the ball screw shaft 29, and a timing belt 34 is provided between the output shaft 33 of a mold-clamping motor 28 such as a servomotor or the like and the pulley 32.

In the mold-clamping apparatus 20, when the mold-clamping motor 28, which is a drive part, is driven, a rotation of the mold-clamping motor 28 is transmitted to the ball screw shaft 29 through the timing belt 34. Then, the rotating motion is converted into a linear motion by the ball screw shaft 29 and the nut 31, and the toggle mechanism 27 is operated. By the operation of the toggle mechanism 27, the movable platen 22 moves along the tie bars 25, and a mold close, a mold clamp and mold open are performed. A position detector 35 is connected to a rear end of the output shaft 33 of the mold-clamping motor 28. The position detector 35 detects a position of the crosshead 30 moving in association with the rotation of the ball screw shaft 29 or the movable platen 22 connected to the crosshead 30 by the toggle mechanism 27 by detecting a number of revolutions or an amount of revolutions of the mold-clamping motor 28.

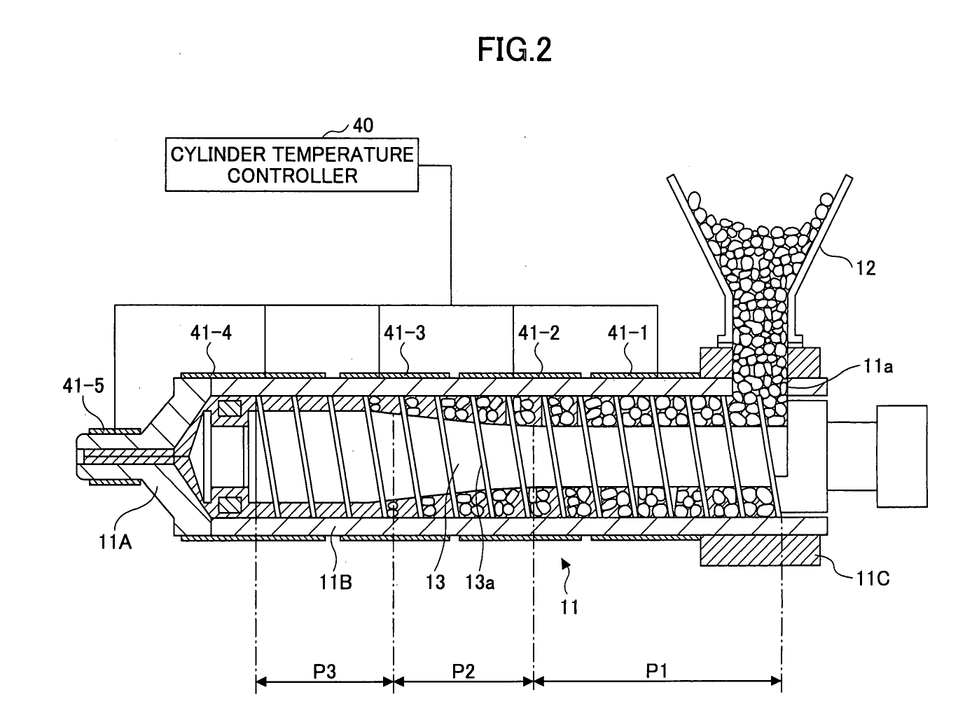

In addition to the above-mentioned structure, the injection molding machine according to the present embodiment is provided with a cylinder temperature controller 40. The cylinder temperature controller 40 controls temperatures of a plurality of heaters 41-1 to 41-4 (refer to FIG. 2), and sets up a temperature profile of the heating cylinder 11 automatically.

Next, a description will be given in detail, with reference to FIG. 2, of the heating cylinder 11. FIG. 2 is a cross-sectional view of the heating cylinder 11. The heating cylinder 11 has a nozzle part 11A on a tip side, a heating cylinder body part 11B, and a cooling cylinder part 11C attached to a resin supply side at the rear end of the heating cylinder 11.

A material supply hole 11a is formed to extend through the rear end of the heating cylinder body part 11B and the cooling cylinder part 11C so that a resin supplied to the hopper 12 is supplied to an interior of the heating cylinder body part 11B through the material supply hole 11a. The screw 13 is arranged rotatably and movably forward and rearward in the interior of the heating cylinder body part 11B so that the supplied resin is filed in a space between an inner wall of the heating cylinder body part 11B and a flight 13a formed in the screw 13. The resin as a molding material supplied inside the heating cylinder body part 11B is moved to the front of the heating cylinder body part 11B, that is, leftward in FIG. 2 by a movement of the flight 13a in association with the rotation of the screw 13.

The heating cylinder body part 11B is provided with a plurality of heaters 41-1, 41-2, 41-3 and 41-4 so as to heat the heating cylinder 11 at a predetermined temperature. The resin being move forward by the screw 13 in the heating cylinder body part 11B is heated by heat from the heaters 41-1 to 41-4. Moreover, a sharing force is exerted on the resin in association with the movement of the resin due to the rotation of the screw 13 and a heat is generated, and the resin is turned into a melted state as it moves forward in the heating cylinder 11. The resin is set in a completely melted state at the tip of the heating cylinder body part 11B. Then, the screw 13 moves rearward as the melted resin is accumulated in front of the screw 13. After the screw 13 moves rearward by a predetermined distance, that is when a predetermined amount of resin is accumulated in front of the screw 13, the rotation of the screw 13 is stopped. Then, by moving the screw 13 forward in the state where the rotation of the screw 13 is stopped, the melted resin is injected into the mold from the nozzle part 11A at the tip.

In a portion where a resin is supplied from the hopper 12 in the heating cylinder body part 11B, it is necessary to maintain the temperature of the heating cylinder body part 11B at a predetermined temperature so that the resin is not softened or melted. For example, this predetermined temperature is about 70° C. Since the heating cylinder body part 11B is heated by the heaters 41-1 to 41-4, it is necessary to cool conversely to cool the portion where the resin is supplied from the hopper 12 so as to maintain it at, for example, 70° C. or below. Thus, the cooling cylinder 11C is provided on the rear end of the heating cylinder body part 11B so that the hopper 12 is attached to the heating cylinder body part 11B via the cooling cylinder 11C. A passage through which a cooling medium or cooling water flows is formed in the cooling cylinder 11C so that the rear end of the heating cylinder body part 11B is cooled by flowing the cooling medium or the cooling water therethrough to maintain it at, for example, 70° C. or below.

The flight 13a of the screw, which rotates and moves forward and rearward in the heating cylinder body part 11B, is distinguished as a supply part P1, a compression part P2, and a metering part P3 along the axial direction from the rear (resin supply side) to the front (nozzle side). The supply part P1 is also referred to as a feed zone, which is a part to which a resin is supplied. The compression part P2 is also referred to as a compression zone, which is a part where the supplied resin is melted while being compressed. The metering part P3 is also referred to as a metering zone, which is a part where the melted resin is metered by a certain amount.

The resin, which has moved in association with a rotation of the screw 13 from the rear end where the cooling cylinder 11 is provided toward the tip of the heating cylinder body part 11B, is heated at the supply part P1 by receiving a heat from the heating cylinder body part 11B, softened and melted at the compression part P2 by the heat from the heating cylinder body part 11B and a heat due to sharing, metered at the metering part P3 in a completely melted state, and injected from the nozzle part 11A.

On the other hand, the heating cylinder body part 11B is divided into four zones, and the heaters 41-1 to 41-4 are provided on the circumference of the heating cylinder body part 11B corresponding to each zone. The zone provided with the heater 41-1 is set as Z1, the zone provided with the heater 41-2 is set as Z2, the zone provided with the heater 41-3 is set as Z3, and the zone provided with the heater 41-4 is set as Z4. Each of the heaters 41-1 to 41-4 is connected to the cylinder temperature controller 40, and generates a heat by an electric current supplied from the cylinder temperature controller 40 so as to be capable of heating the heating cylinder body part 11B on an individual zone basis. The cylinder temperature controller 40 is capable of appropriately changing and setting the temperature distribution, that is, a temperature profile of the heating cylinder by adjusting the electric current supplied to each of the heaters 41-1 to 41-4. It should be noted that the number of divided zones, that is, the number of heaters separately provided is not limited to four. If the number of zones is large, a fine temperature setting can be done, which permits a finer setting of the temperature profile.

Additionally, an amount of cooling water supplied to the cooling cylinder part 11C provided at the rear end of the heating cylinder body part 11B is also controlled by the cylinder temperature controller 40 so that the temperature of the rear end of the heating cylinder body part 11B can be controlled.

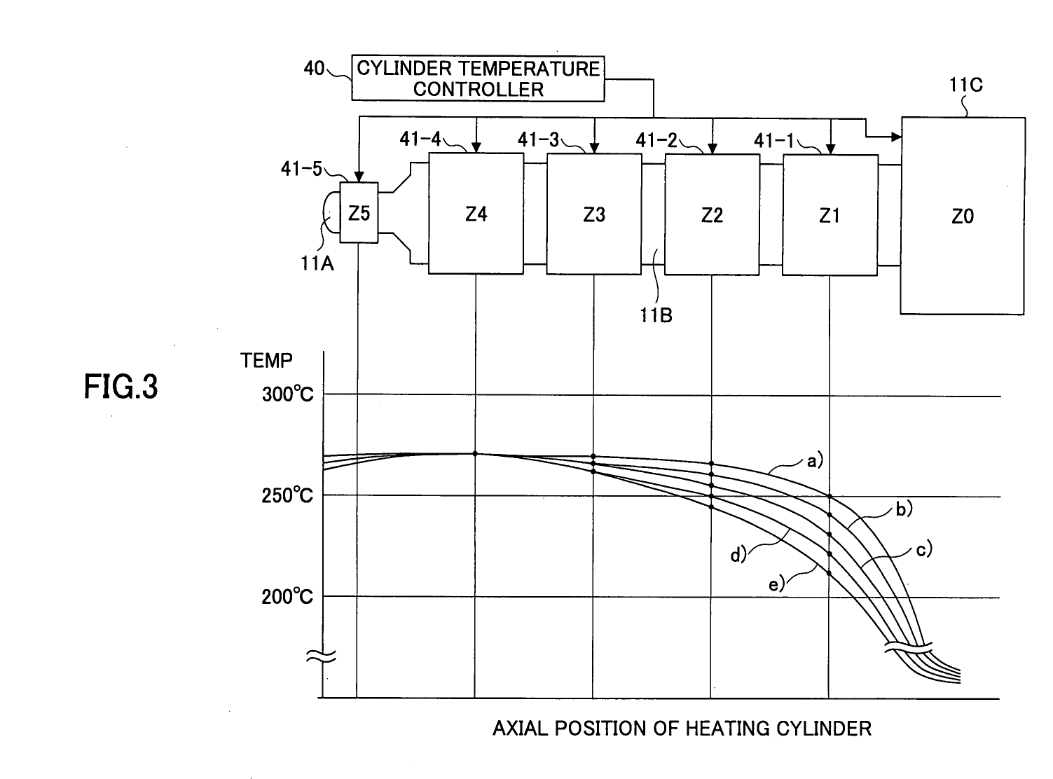

Here, a description will be given, with reference to FIG. 3, of the temperature profile of the heating cylinder 11. FIG. 3 is a graph indicating the temperature distribution of the heating cylinder 11.

As mentioned above, the heating cylinder 11 is divided into the zones Z0 to Z5, and the cooling cylinder part 11C is provided in the zone Z0. The heaters 41-1, 41-2, 41-3 and 41-4 are provided in the zones Z1, Z2, Z3 and Z4, respectively.

The temperature in the zone Z4 closest to the nozzle part 11A of the heating cylinder body part 11B is a temperature which is set beforehand based on a kind of a resin and a shape and an appearance of a molded product, and is set to, for example, a temperature recommended by a resin material manufacturer. Here, it is assumed that the temperature of the zone Z4 is set to 270° C. The setting temperature of 270° C. is set by an operator by inputting a setting temperature to the injection molding machine (the cylinder temperature controller 40). On the other hand, the temperature of the zone Z5 at the rear end of the heating cylinder body part 11B in which the cooling cylinder part 11C is provided is set to, for example, 70° C., which is a temperature at which the resin is not softened and melted. The setting temperature of the cooling cylinder part 11C is also input by the operator.

As mentioned above, the temperatures of zone Z4 of the nozzle side and the supply side are set by an operator. Conventionally, the temperatures of the zones Z3, Z2 and Z1 therebetween were also set by an operator, and, thereby, the temperature profile of the heating cylinder 11 was set. Accordingly, the temperature profile was dependent on the temperature setup of the operator, and if a resin is used for the first time by the operator or a molding condition is used for the first time by the operator, there may be a case where an inappropriate temperature profile is set. Especially, the resin temperature in the zone Z4 corresponding to the front of the screw, when the metering process to accumulate a melted resin is completed, is given an influence of the heat generation of the resin due to sharing and a heat supplied from the heaters 41-1 to 41-3 in the feed zone P1 and the compression zone P2. On the other hand, if the resin temperature of the zone Z4 is unstable, the temperature of the melted resin in front of the screw 13, which is to be filled into the mold, becomes unstable, which causes the molding to be unstable due to fluctuation of the injection pressure. Thus, in order to stabilize the resin temperature of the zone Z4, it is necessary to appropriately set the temperatures of the zones Z1 to Z3 in response to the molding condition.

Thus, in the present embodiment, the cylinder temperature controller 40 automatically sets the temperatures of the zones Z3, Z2 and Z1 based on the conditions, such as 1) a mold cycle time, 2) a metering stroke of the screw, and 3) resin information.

1) Temperature setup based on the mold cycle time.

When an operator inputs an assumed mold cycle time based on a size (a wall thickness, a weight) of a molded product, a mold temperature and experience values, the molding machine (the cylinder temperature controller 40) automatically calculates the temperatures of the zones Z3, Z2 and Z1 as follows. Hereinafter, Z1-Z4 represent the setting temperatures of the zones Z1-Z4.

a) cycle less than 10 seconds: Z3=Z4, Z2=Z4-5, Z1=Z4-20

b) 10 seconds to less than 30 seconds: Z3=Z4-5, Z2=Z4-10, Z1=Z4-30

c) 30 seconds to less than 60 seconds: Z3=Z4-10, Z2=Z4-20, Z1=Z4-50

d) 60 seconds to less than 180 seconds: Z3=Z4-10, Z2=Z4-20, Z1=Z4-50

e) equal to or greater than 180 seconds: Z3=Z4-10, Z2=Z4-25, Z1=Z4-60

The setting temperature of each zone acquired by the above-mentioned calculations is shown below when the setting temperature of the zone Z4 is supposed to be 270° C.

| cycle time | Z4 (° C.) | Z3 (° C.) | Z2 (° C.) | Z1 (° C.) |
|---|---|---|---|---|
| a) | 270 | 270 | 265 | 250 |
| b) | 270 | 265 | 260 | 240 |
| c) | 270 | 265 | 255 | 230 |
| d) | 270 | 260 | 250 | 220 |
| e) | 270 | 260 | 245 | 210 |

FIG. 3 indicates the temperature profile of the heating cylinder 11 when the temperature of each zone is set as shown in the above a) to e). It is appreciated that the slope of the temperature profile between the zone Z4 and the zone Z1 is set steeper as the mold cycle time is longer. That is, if the mold cycle time is long, the resin stays in the heating cylinder correspondingly for a long time, which may heat the resin excessively. In order to avoid that, a setting is made so that the nozzle part 11A side of the heating cylinder body part 11B is at a desired 270%, and the temperature is set lower as it goes away from the nozzle part 11A side as the mold cycle time becomes longer. Thereby, the time of the melted resin being heated at a temperature equal to or higher than the melting temperature is shortened, and a problem of resin burning or the like does not occur even if the mold cycle time is long. Since the temperature profile is automatically set by the cylinder temperature controller 40, the operator is not required to perform a complicated operation such as determining and inputting the setting temperature of each zone in consideration of the mold cycle time, which can prevent an occurrence of a problem due to setting error.

2) Temperature setting based on the metering stroke of the screw.

In addition to the mold cycle time, the metering stroke can be an index. The metering stroke serves as an index which reflects a size (thickness, weight, etc.) of a molded product in the temperature profile. For example, a value of the metering stroke L divided by the diameter φD of the screw is set as an index. When the diameter φD of the screw 13 is 25 mm and the metering stroke L is 37.5 mm, L/D=37.5/25=1.5 is calculated. Thus-obtained L/D is set as an index as follows.

i) L/D=less than 0.5: down two ranks from the temperature setting in 1)

ii) 0.5 to less than 1: down one rank from the temperature setting in 1)

iii) 1 to less than 2.5: the same as the temperature setting in 1)

iv) L/D=2.5 or more: up one rank from the temperature setting in 1)

Here, “down two ranks from the temperature setting in 1)” means that the temperature profile obtained from the temperature setting based on 1) temperature setting based on the cycle index is shifted, for example, from a) to c). That is, even if the mold cycle time is long, an amount of the resin injected for each cycle is large if the metering stroke is large, and, correspondingly, a stay time of the resin in the heating cylinder body part 11B is shortened. Therefore, if the metering stroke is large, the heating cylinder body part 11B is set at a high temperature in its entirety so that the resin is heated by the entire heating cylinder body part 11B so as to set a temperature profile of a small temperature slope.

3) Temperature setting based on resin information.

Many resins used for injection molding are thermoplastic resins, and are classified into crystalline resins and noncrystalline resins. Generally, the crystalline resins require a larger amount of heat for melting than the noncrystalline resins. Accordingly, it is necessary for the crystalline resins to increase the time for heating at a high temperature, and a temperature profile in which a high temperature state lasts long and a temperature slope is small may be set.

Then, in the present embodiment, the injection molding machine retains a table regarding resin information so that if the resin information is input, it is determined whether the resin is a crystalline resin or a noncrystalline resin and reflects the determination result in the temperature setting by the cylinder temperature controller 40. An operator may input directly to the molding machine whether it is a crystalline resin or a noncrystalline resin without determining from the table.

For example, as an example of reflecting the resin information in the temperature setting, if the resin used is a crystalline resin, the temperature setting one rank up from the temperature setting obtained by the setting method 1), and if it is a noncrystalline resin, the temperature setting obtained by the setting method 1) is used without change. In this case, if the temperature setting obtained by the setting method 1) is a), the temperature setting of a) is used without change.

Moreover, as the resin information which the molding machine retains, the maximum temperature may be determined previously for each kind of resin and for each zone. For example, if it is desirous to decrease a viscosity of a resin extremely, there may be a case where the temperature of the zone Z4 is set at a high temperature which is not set normally. In such a case, if the calculation is made by the setting method of the above-mentioned 1), the setting temperature of the zone Z1 is also set to an extremely high temperature, which may cause the resin to be melted or softened at the resin supply part.

If, for example, the molded product is an optical disc, there is a case where a polycarbonate resin is used as a molding material and the temperature of the melted resin (that is, the temperature of Z4) is set near 380° C., and the mold cycle time is equal to or less than 10 seconds. In such a case, according to the above-mentioned setting method of 1), the temperature of the zone Z1 is 360%. If the temperature of the zone Z1 is set to 360%, the polycarbonate resin is melted at the resin supply part.

In order to avoid such a problem, it is possible to prevent an unnecessarily high temperature setting from being set automatically by providing an upper limit value to the setting temperature of each of the zones Z1 to Z3.

As mentioned above, in the present embodiment, the setting temperatures of the zones Z3, Z2 and Z1 are set based on the calculations based on at least one information from among the mold cycle time, the metering stroke and the resin information. Although the setting temperature of the cooling cylinder 11C is set by an operator, the setting temperature of the cooling cylinder 11C may be automatically set by the injection molding machine side (for example, the cylinder temperature controller 40). As an example of the setting, it is considered that the setting temperature of the cooling cylinder part 11C is set based on the setting temperature of the zone Z1 which is close to the cooling cylinder part 11c.

temperature of Z1 is less than 200° C.: 40° C.

200 to less than 250° C.: 50° C.

250 to less than 270° C.: 60° C.

270 to less than 290° C.: 70° C.

290 to less than 310° C.: 80° C.

temperature of Z1 is 200° C. or higher: 90° C.

The method of obtaining the setting temperature of the cooling cylinder part 11C is not limited to the above-mentioned method, and it can be obtained by an arbitrary method. It can be obtained by equations representing such a relationship, or a table prepared by such a relationship is retained so as to obtain the setting temperature directly from the table. The setting temperature of the zone Z0 of the cooling cylinder 11C can be controlled by adjusting an amount of cooling water supplied to the cooling cylinder part 11C.

Moreover, when molding is actuary started with the calculated setting temperatures, there may be a case where a result value of the temperature of the zone Z4 is higher than the setting temperature. This may happen when an amount of heat generated by sharing of the resin is large. In such a case, the setting temperatures of the zones Z3 and Z2 may be corrected based on the difference between the setting temperature and the result temperature of the zone Z4. For example, in a case where the setting temperature of the zone Z4 is 270° C. and the result temperature is 275° C., the result temperature of the zone Z4 can be decreased by decreasing the setting temperature of the zone Z3, and, as a result, the difference between the setting temperature and the result temperature of the zone Z4 can be decreased and eliminated.

As an example which can expect the effect especially using the injection molding machine according to the present invention, there is a plastic lens molding. A camera is made extremely compact in recent years, and an extremely small plastic lens has been used as a lens for a camera.

As a material of a plastic lens, there are cycloolefin copolymer (COC), a polycarbonate resin, an acrylic resin, etc. The plastic lens is an optical component and a high transparency is required, and if such a resin is kept at a high temperature for a long time, it may be altered and the transparency may be lost. Since the plastic lens is extremely thin and a size thereof is small, a volume of each piece is very small. Additionally, the mold cycle time of the plastic lens is 40 seconds to 60 seconds, and the mold cycle time is not short.

If an operator who has handled molded products larger than the plastic lens molds such a small plastic lens, the operator may not recognize the uniqueness in the plastic lens molding and may perform the temperature setting by a conventional setting method, and, as a result, a temperature profile is set according to which the resin stays and heated in the heating cylinder for a long time. In such a case, the resin is degenerated and the quality of the plastic lens is degraded, and moreover the resin is burned in the heating cylinder, which generates a problem in that the heating cylinder must be disassembled and cleaned or replaced.

However, if the injection molding machine according to the present invention is used, since the injection molding machine automatically determines and sets up the temperature profile in consideration of elements such as a mold cycle time and a king of resin, an appropriate temperature profile can always be set even if an operator is inexperienced and a problem due to setting of an erroneous temperature profile can be prevented from being occurred.

It should be noted that although the temperature setting from the zone Z4, which is close to the nozzle part 11A of the heating cylinder body part 11B, to the zone Z1, which is close to the cooling cylinder part 11C in the above mentioned embodiment, the temperature setting of the zone Z5 of the nozzle part 11A can also be performed automatically in accordance with the temperature profile. Further, the same temperature as the temperature of the zone Z4 may be set without adjustment in accordance with the temperature profile. Further, an operator may input the setting temperatures individually while observing the molding condition such as an occurrence of stringiness from the tip of the nozzle.

Additionally, as the heaters 41-1 to 41-5 for heating the zones Z1 to Z5, a band heater may be used in which a coils is embedded in a flexible band so as to generate heat by a resistance of the coil, or an induction heating device may be used.

The present invention is not limited to the specifically disclosed embodiments, and variations and modifications may be made without departing from the scope of the present invention.

The present application is based on priority claiming Japanese patent application No. 2006-068106 filed on Mar. 13, 2006, the entire contents of which are hereby incorporated herein by reference.

### INDUSTRIAL APPLICABILITY

The present invention is applicable to an injection molding machine equipped with an injection apparatus that melts and injects a resin while heating.

1. An injection molding machine equipped with a cylinder to which a molding material is supplied and a metering member that is driven in the cylinder to meter the molding material, comprising:
a plurality of heaters provided in alignment in an axial direction of the cylinder so as to individually heat each part of said cylinder at a predetermined setting temperature; and
a controller that individually controls the setting temperatures of the plurality of heaters,
wherein, when the setting temperature corresponding to a position where a melted resin is accumulated in front of a screw at a time of completion of metering is set from among said setting temperatures by said plurality of heaters, said controller acquires said setting temperatures other than the heater by calculation based on molding conditions.

2. The injection molding machine as claimed in claim 1, wherein said cylinder includes a nozzle part on a side that injects said resin, a cooling cylinder part on a side where said resin is supplied, and a cylinder body part extending between the nozzle part and the cooling cylinder part, and wherein said predetermined one of the setting temperatures is a setting temperature of said heater at a position of said cylinder body part near said nozzle part, and said setting temperatures other than said predetermined one are the setting temperatures from said heater at a position secondly close to said nozzle part to said heater closest to said cooling cylinder.

3. The injection molding machine as claimed in claim 1, wherein said molding conditions include information regarding at least one of a mold cycle time, a metering stroke of said metering member, and a kind of said resin.

4. The injection molding machine as claimed in claim 1, further comprising a cooling part that cools an end side of said cylinder, and said controller automatically sets a setting temperature of the cooling part.

5. The injection molding machine as claimed in claim 1, wherein said controller corrects the setting temperature acquired by said calculation based on said predetermined one of said setting temperatures.
